(19) United States
(12) Patent Application Publication
(10) Pub. No.: US 2025/0158330 A1
(43) Pub. Date: May 15, 2025

(54) CONNECTOR FOR A FLAT CONNECTION OBJECT

(71) Applicant: P-TWO INDUSTRIES INC., Taoyuan City (TW)

(72) Inventors: Hsien-Chang LIN, Taoyuan City (TW); Chun-Wei CHANG, Taoyuan City (TW); Han-Min HSU, Taoyuan City (TW)

(21) Appl. No.: 18/883,264

(22) Filed: Sep. 12, 2024

(30) Foreign Application Priority Data
Nov. 14, 2023 (TW) 112143822

(51) Int. Cl. H01R 13/635; H01R 12/77

(52) U.S. Cl. CPC H01R 13/635; H01R 12/774; H01R 12/775

(57) ABSTRACT

A connector for a flat connection object is disclosed. The connector comprises: an insulating housing, a plurality of contacts held by the insulating housing, upper and lower electrically conductive shells fixed to the insulating housing. The lower electrically conductive shell comprises a pair of locking portions each of which is normally biased to a locking position and has a pressed portion. The upper electrically conductive shell comprises a pair of unlocking portions each of which includes an actuator positioned above the pressed portion. By depressing the actuator, the locking portion is displaced out of the locking position so that locking of the flat connection object is released. Each unlocking portion further comprises a tactile indicator. In absence of a visual indicator, users can rely on the tactile indicator portion to confirm whether their fingers are accurately positioned on a pressed position for releasing the locking of the flat connection object.

### CROSS-REFERENCES TO RELATED APPLICATIONS

This application claims the benefit of priority to Taiwanese Patent Application No. 112143822 filed on Nov. 14, 2023, which is hereby incorporated by reference in its entirety.

### BACKGROUND OF THE INVENTION

### Field of the Invention

The present invention relates to a connector for a flat connection object such as a flexible flat cable (FFC), a flexible flat circuit (FPC), or the like, particularly a connector capable of releasing the locking of the flat connection object by pressing an actuator formed on a metal shell.

### Descriptions of the Related Art

Japanese Patent Publication No. 2018-097979A (Patent Document 1) discloses a connector for a wiring board-like component (such as a flexible flat cable or a flexible printed circuit). The connector of Patent Document 1 has a pivatably operated actuator, and the wiring board-like component is locked and unlocked by pivotably operating this actuator. However, this actuator has a certain thickness, making it difficult to achieve a thinner connector. Additionally, this connector requires a space necessary for operating the actuator, which is not suitable to be installed in a narrow space.

U.S. Patent Publication No. 2022/0149565A1 (Patent Document 2) discloses an easy-lock connector with a press-to-unlock structure. Patent Document 2 is a prior application filed by the applicant of the present application. In Patent Document 2, the press-to-unlock structure is integrated into the metal shell of the connector. There is no need to increase the number of parts of the connector to provide the press-to-unlock function. However, when the connector of Patent Document 2 is applied to a small precision narrow-pitch connector, the pressing part may be made in an area smaller than or equal to 2.2×1.6 mm². In this case, it is difficult to ensure a sufficient area for setting up a visual indicator on the pressing part because part of the area is already occupied by a rib. Even if the visual indicator is provided on the pressing part or other parts of the connector, such an indicator is sometimes difficult to recognize or cannot be seen, especially in a dark condition or a condition that the pressing part cannot be viewed directly from above the connector. Additionally, the size of this pressing part is extremely small, causing the visual indicator to be completely covered by the user's fingertip before the fingertip accurately reaches above the pressing part. When the visual indicator is completely covered by the user's fingertip and the user's fingertip has not accurately positioned itself above the pressing part, the user cannot visually confirm whether the fingertip is accurately positioned above the pressing part. In this case, the user can only repeatedly press at different positions until the correct pressing position is found.

To compensate for the shortcoming of the visual indicator, it is desirable to provide an indicator other than the visual indicator, such as a tactile indicator, on the connector in a simple, reliable, and cost-effective manner.

### SUMMARY OF THE INVENTION

One object of the present invention is to provide a connector for a flat connection object, capable of releasing the locking of the flat connection object by pressing an actuator.

Another object of the present invention is to provide a connector for a flat connection object, capable of indicating the pressing position for releasing the locking of the flat connection object in a tactually perceptible manner.

According to one aspect of the present invention, a connector for a flat connection object is provided, the flat connection object comprising a pair of notches and a plurality of electrode portions, the plurality of electrode portions being formed on an insertion end of the flat connection object, the pair of notches being formed on two opposite lateral edges of the flat connection object, the connector comprising: an insulating housing including an opening for insertion of the flat connection object; a plurality of contacts held by the insulating housing, each contact including a contact portion extending into the opening and being to be in contact with one of the plurality of electrode portions and a connection terminal portion opposite to the contact portion and extending out of the insulating housing; an upper electrically conductive shell and a lower electrically conductive shell, the upper electrically conductive shell and the lower electrically conductive shell being fixed to the insulating housing; wherein the lower electrically conductive shell includes a lower shell body portion and a pair of locking portions respectively positioned on two ends of the lower shell body portion, each locking portion is normally and elastically biased to a locking position, each locking portion includes a pressed portion, a first extension portion and a stop tab, the first extension portion is extended into the opening from the pressed portion, the stop tab is formed on a distant end so that when the flat connection object is inserted into the opening, the stop tabs of the pair of locking portions are engaged with the pair of notches for preventing the flat connection object from being removed from the connector; the upper electrically conductive shell includes an upper shell body portion and a pair of unlocking portions respectively positioned on two ends of the upper shell body portion, each unlocking portion includes an elastic arm and an actuator portion, the actuator portion is formed on a distant end of the elastic arm and positioned above the pressed portion, the pressed portion is pushed downward by pressing the actuator portion so that the locking portion is biased out of the locking position so as to release locking of the flat connection portion; each unlocking portion further includes a tactile indicator portion positioned above the actuator portion, the tactile indicator portion has an upper surface which is positioned at a level higher than an upper surface of the upper shell body portion so that unevenness caused by the tactile indicator portion is tactually perceptible for indicating a pressed position for releasing the locking of the flat connection object.

According to the connector of the present invention, the tactile indicator portion is integrally formed with the actuator portion.

According to the connector of the present invention, the tactile indicator portion is formed separately from the upper electrically conductive shell and attached to the actuator by adhesive agent, binding agent or solder.

According to the connector of the present invention, the upper surface of the tactile indicator portion is textured.

According to the connector of the present invention, the upper surface of the tactile indicator portion is formed with a relief or recessed pattern or character.

According to the connector of the present invention, the upper surface of the tactile indicator portion is formed with a printed pattern or character.

According to the connector of the present invention, wherein the upper surface of the tactile indicator portion is colored.

According to the connector of the present invention, each locking portion further includes a U-shaped bent portion and a second extension portion, the second extension portion is extended from the lower shell body portion, and the pressed portion and the second extension portion are connected by the U-shaped bent portion.

According to the connector of the present invention, the actuator portion is formed with a protrusion protruded toward the pressed portion.

According to the connector of the present invention, the stop tab has a front edge inclined toward an insertion direction of the flat connection object, when the flat connection object is inserted into the opening, the insertion end of the flat connection object is abut against the front edge of the stop tab, and further movement of the flat connection object in the insertion direction causes the stop tab to be biased downwardly so that the locking portion is biased away from the locking position.

The connector of the present invention provides a simple, reliable and easy manner allowing users to quickly lock and release the flat connection object while using a tactile indicator portion to assist the users in determining the position for operating the unlocking portion.

The above and other objects and advantages of the present invention will become apparent from the accompanying drawings and the following detailed description.

### BRIEF DESCRIPTION OF THE DRAWINGS

FIG. 1 is a perspective view of a connector for a flat connection object according to the embodiment of the present invention.

FIG. 2 is another perspective view of the connector for a flat connection object according to the embodiment of the present invention, where a portion of the upper electrically conductive shell is not shown.

FIG. 3 is an exploded perspective view of the connector for a flat connection object according to the embodiment of the present invention.

FIG. 4 is a view schematically illustrating the state where a flat connection object is inserted into the connector according to the embodiment of the present invention.

FIG. 5 is a perspective view of the lower electrically conductive shell.

FIG. 6 is a view schematically illustrating the engagement of the flat connection object by the locking portions.

FIG. 7 is a perspective view of the upper electrically conductive shell.

FIG. 8 is a side view of the upper electrically conductive shell.

FIG. 9 is a view partially showing the upper and lower electrically conductive shells.

### DETAILED DESCRIPTION OF THE PREFERRED EMBODIMENT

The connector for a flat connection object according to the embodiment of the present invention will be described with reference to the drawings. In the drawings, the same components or components with similar functions are denoted by the same reference numerals. The drawings are not necessarily drawn to scale.

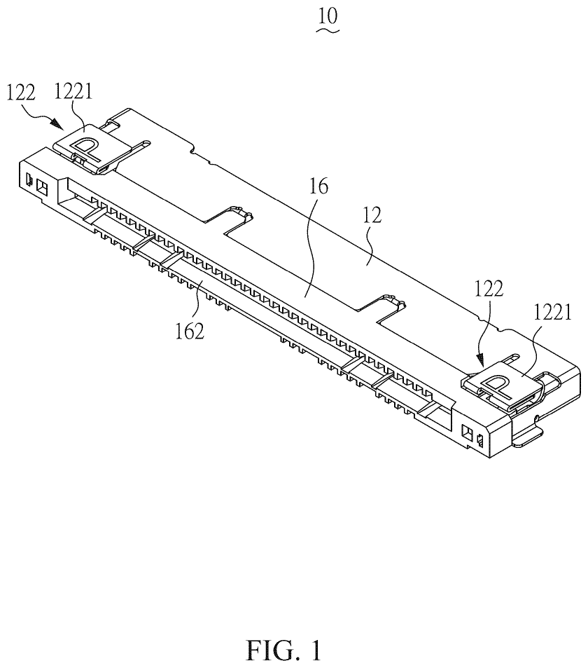

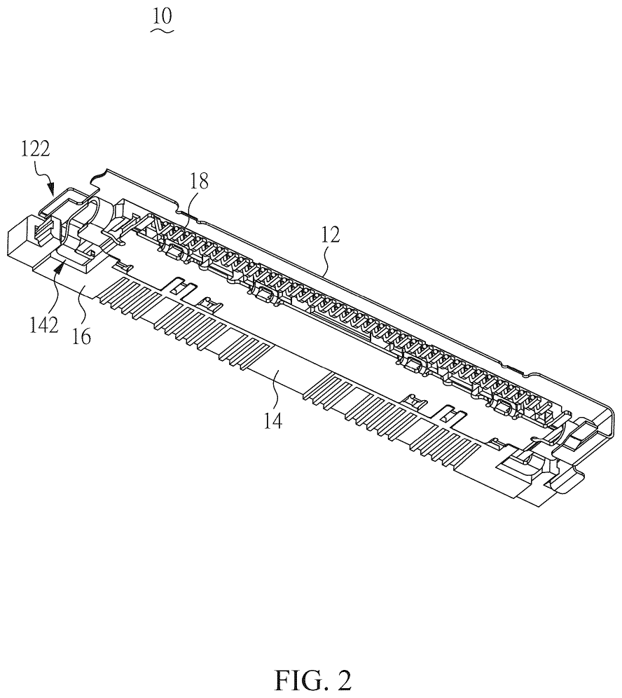

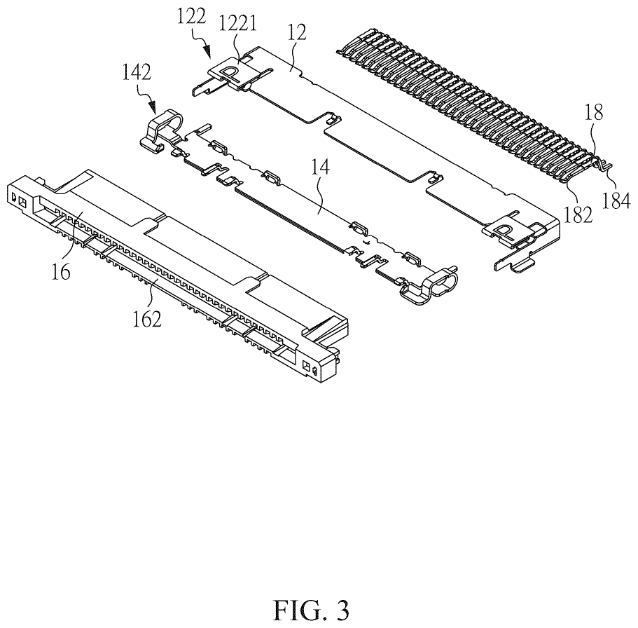

FIG. 1 is a perspective view of the connector for a flat connection object according to the embodiment of the present invention. FIG. 2 is another perspective view of the connector for a flat connection object according to the embodiment of the present invention. To further illustrate the internal details of the connector, a portion of the upper electrically conductive shell is not shown in FIG. 2. FIG. 3 is an exploded perspective view of the connector for a flat connection object according to the embodiment of the present invention. The connector for a flat connection object is entirely denoted by the reference numeral 10. The constituent components of the connector 10 according to the embodiment of the present invention is schematically described by referring to FIGS. 1 to 3. The connector 10 comprises an insulating housing 16, an upper electrically conductive shell 12, a lower electrically conductive shell 14 (shown in FIGS. 2 and 3), and a plurality of contacts 18 (shown in FIGS. 2 and 3).

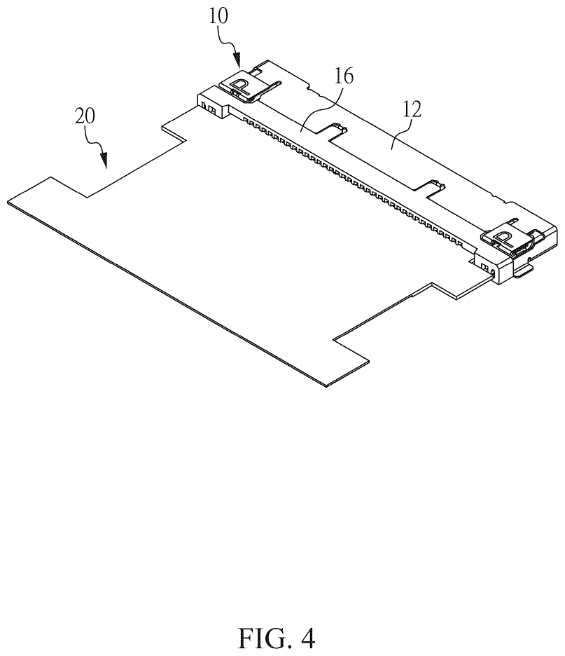

The insulating housing 16 is made of insulating synthetic resin or polymer material. The insulating housing 16 is formed with an opening 162 for the insertion of a flat connection object 20 (shown in FIG. 4). Each of the upper electrically conductive shell 12 and the lower electrically conductive shell 14 is made of metal or alloy material. The upper electrically conductive shell 12 and the lower electrically conductive shell 14 are fixed to the insulating housing 16, so that a portion of the insulating housing 16 is covered by the upper electrically conductive shell 12 and the lower electrically conductive shell 14. The plurality of contacts 18 are held by the insulating housing 16. Each contact 18 is made of copper or copper alloy. Each contact 18 has a contact portion 182 and a connection terminal portion 184 opposite to the contact portion 182. The contact portion 182 extends into the opening 162, and the connection terminal portion 184 protrudes from the insulating housing 16. The connection terminal portion 184 can be soldered onto a solder pad formed on a printed circuit board (not shown) by surface-mount technology (SMT).

According to the embodiment of the present invention, the connector 10 automatically locks the flat connection object 20 inserted into the connector 10, preventing the flat connection object 20 from being disengaged from the connector 10. By pressing a pair of unlocking portions 122 integrally formed on the upper electrically conductive shell 12, the locking of the flat connection object 20 is released, allowing the flat connection object 20 to be withdrawn from the connector 10.

To indicate the pressed position for releasing the locking of the flat connection object 20, a tactile indicator portion 1221 is provided on each unlocking portion 122. Therefore, users can use their fingers to confirm the pressed position.

FIG. 4 schematically shows the state where the flat connection object 20 is inserted into the connector 10. The flat connection object 20 may be a flexible flat cable (FFC) or a flexible printed circuit (FPC) but is not limited thereto.

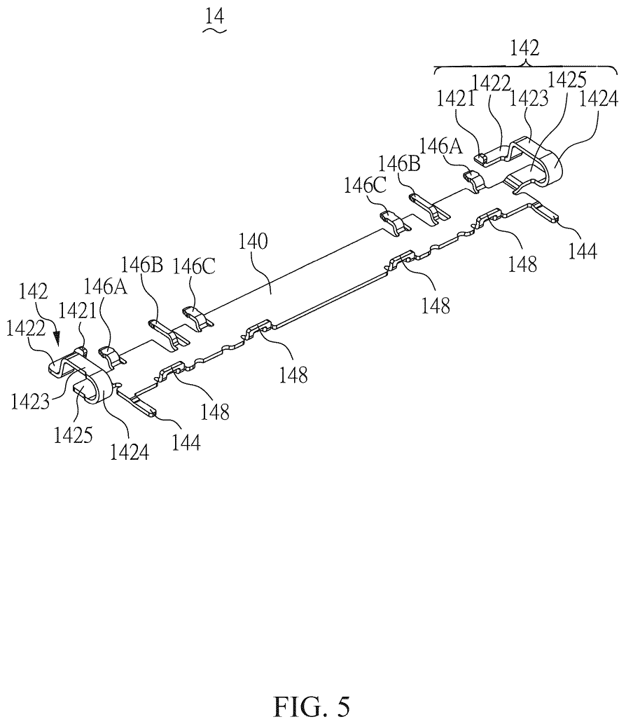

FIG. 5 is a perspective view of the lower electrically conductive shell. The description of details of the lower electrically conductive shell 14 is made by referring to FIG. 5.

The lower electrically conductive shell 14 is manufactured by punching and bending a metal sheet. The lower electrically conductive shell 14 is a single-piece metal component, but is not limited thereto. The lower electrically conductive shell 14 may be composed of a plurality of parts.

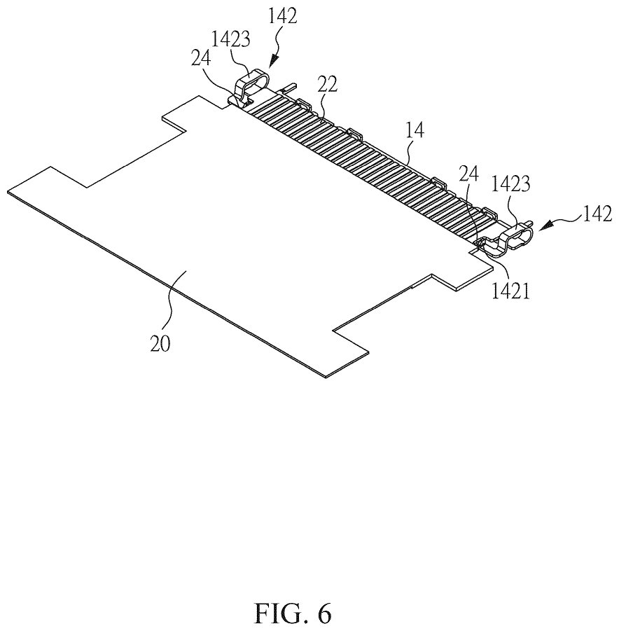

The lower electrically conductive shell 14 includes a lower shell body portion 140 and a pair of locking portions 142 respectively located at two ends of the lower shell body portion 140. Each locking portion 142 is moved between a locking position and an unlocking position. Each locking portion 142 is normally and elastically biased to the locking position. The locking portion 142 comprises a stop tab 1421, a first extension portion 1422, a pressed portion 1423, a U-shaped bent portion 1424, and a second extension portion 1425. The second extension portion 1425 extends outwardly from the lateral side of the lower shell body portion 140. The pressed portion 1423 is connected to the second extension portion 1425 through the U-shaped bent portion 1424, so that the pressed portion 1423 is positioned to be adjacent to or in contact with the upper electrically conductive shell 12. The first extension portion 1422 extends from the pressed portion 1423 into the opening 162 of the insulating housing 16. The stop tab 1421 is formed at the distal end of the first extension portion 1422, so that when the flat connection object 20 is inserted into the opening 162 of the insulating housing 16, the stop tab 1421 is engaged with the notch formed on the lateral edge of the flat connection object 20 (shown in FIG. 6), preventing the flat connection object 20 from being pulled out or disengaged from the connector 10.

The stop tab 1421 is constructed not to obstruct the insertion of the flat connection object 20. Specifically, the front edge of the stop tab 1421 is inclined toward the insertion direction of the flat connection object 20. During the process of insertion of the flat connection object 20 into the opening 162 of the insulating housing 16, the insertion end of the flat connection object 20 abuts against the front edge of the stop tab 1421. Further movement of the flat connection object 20 in the insertion direction causes the stop tab 1421 to be biased downward, so that the locking portion is biased from the locking position to the unlocking position. Therefore, the stop tab 1421 does not obstruct the insertion of the flat connection object 20. Locking of the flat connection object 20 can be achieved simply by inserting the flat connection object 20 into the opening 162 of the insulating housing 16, without the need for additional operation of other components.

To secure the lower electrically conductive shell 14 to the insulating housing 16, a plurality of held portions 146A, 146B, 146C are formed at the front edge of the lower electrically conductive shell 14, and a plurality of locking portions 148 are formed at the rear edge of the lower electrically conductive shell 14. Each held portion has barbs. Each held portion is inserted into a corresponding holding hole formed in the insulating housing 16 in an interference-fit manner. Each locking portion 148 is engaged with a corresponding stub formed on the rear side of the insulating housing 16. In this way, the lower electrically conductive shell 14 is fixed to the insulating housing 16.

The lower electrically conductive shell 14 also has two fixed portions 144. The fixed portions 144 are fixed to the printed circuit board by soldering. Optionally, the lower electrically conductive shell 14 may be grounded.

FIG. 6 is a view schematically illustrating the engagement of the flat connection object 20 with the locking portions 142. With reference to FIG. 6, the composition of the flat connection object 20 and the connection relationship between the flat connection object 20 and the locking portions 142 are described.

The flat connection object 20 includes a pair of notches 24 and a plurality of electrode portions 22 formed at the insertion end of the flat connection object 20. The pair of notches 24 are formed respectively on the opposite lateral edges of the flat connection object 20 and adjacent to the insertion end. When the flat connection object 20 is inserted into the opening 162 of the insulating housing 16, on one hand, the contact portions 182 of the plurality of contacts 18 are in electrical contact with the plurality of electrode portions 22 respectively, and on the other hand, the stop tabs 1421 of the locking portions 142 are engaged with the pair of notches 24, preventing the flat connection object 20 from being pulled out or detached from the connector 10.

When the pressed portions 1423 are pressed downward, the stop tabs 1421 are disengaged from the notches 24. At this time, the locking of the flat connection object 20 is released, allowing the flat connection object 20 to be pulled out or detached from the connector 10.

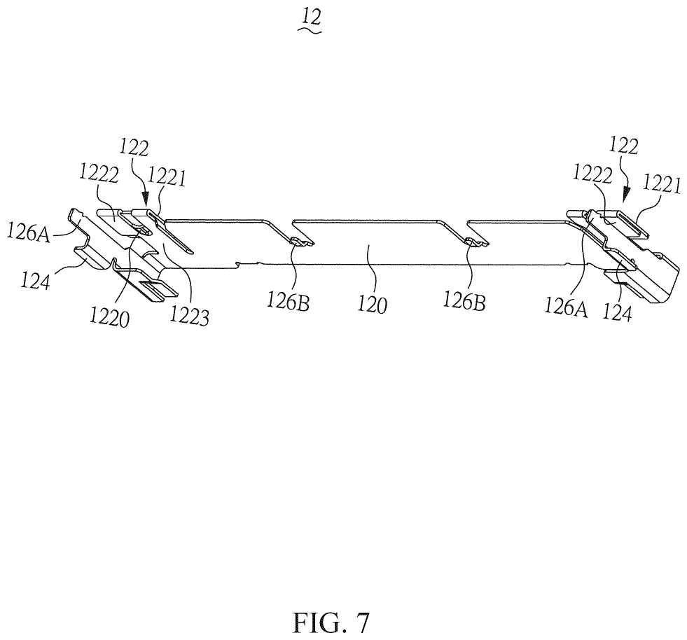

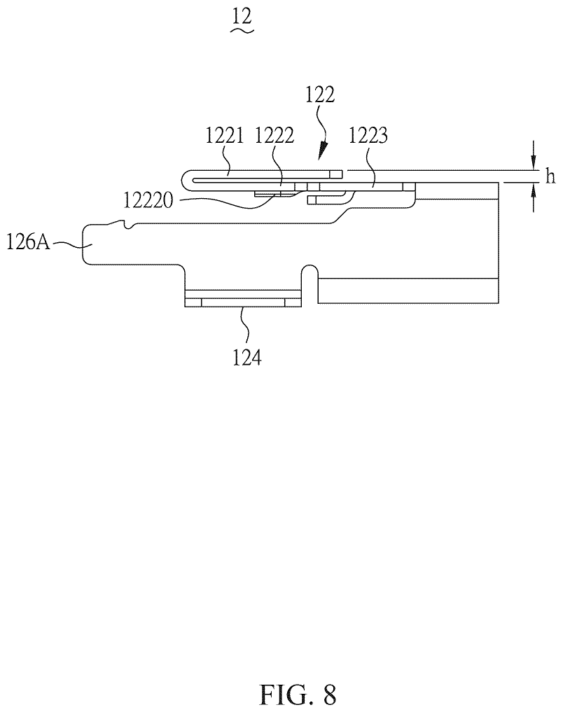

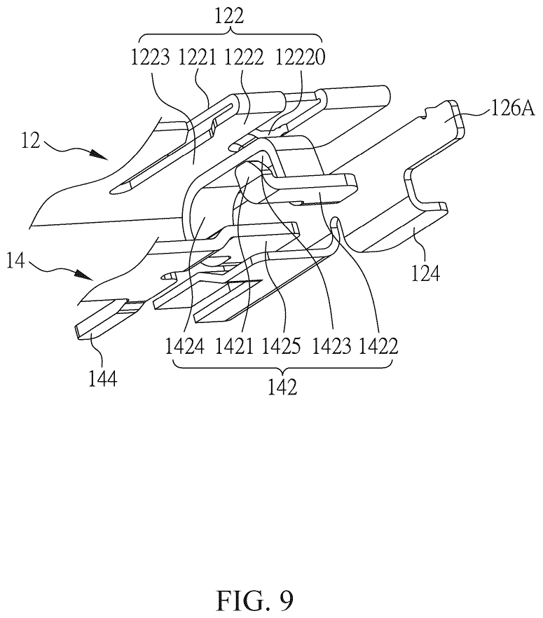

FIG. 7 is a perspective view of the upper conductive shell. FIG. 8 is a side view of the upper conductive shell. FIG. 9 is a view partially illustrating the upper conductive shell and the lower conductive shell. With reference to FIGS. 7, 8, and 9, the details of the upper conductive shell 12 and the connection relationship between the upper conductive shell 12 and the lower conductive shell 14 are described.

Similar to the lower conductive shell 14, the upper conductive shell 12 is also manufactured by punching and bending a metal sheet. According to the embodiment of the present invention, the upper conductive shell 12 is a single-piece metal component, but not limited thereto. The upper conductive shell 12 may be composed of a plurality of parts.

The upper conductive shell 12 includes an upper shell body portion 120 and a pair of unlocking portions 122 respectively located at two opposite ends of the upper shell body portion 120. Each unlocking portion 122 comprises an elastic arm 1223 and an actuator portion 1222 formed at the distal end of the elastic arm 1223. The actuator portion 1222 is positioned above the pressed portion 1423 of the locking portion 142. The actuator portion 1222 is formed with a protrusion 12220 protruding toward the pressed portion 1423 of the locking portion 142. By pressing the actuator portion 1222 of the unlocking portion 122, the pressed portion 1423 of the locking portion 142 is pushed downward, so that the locking portion 142 is biased away from the locking position for releasing the locking of the flat connection object 20. In the condition that the actuator portion 1222 is not pressed, the protrusion 12220 can be in contact with or adjacent to the pressed portion 1423 of the locking portion 142.

Each unlocking portion 122 also includes a tactile indicator portion 1221 located above the actuator portion 1222 to indicate the pressed position for releasing the locking of the flat connection object 20. As shown in FIG. 8, the upper surface of the tactile indicator portion 1221 is set higher than the upper surface of the upper shell body portion 120. The height difference h between the upper surface of the tactile indicator portion 1221 and the upper surface of the upper shell body portion 120 is sufficient to cause a tactually perceptible unevenness. Generally, unevenness caused by height differences of several hundred micrometers can be perceived by the skin of the user's finger. Therefore, the user can use their finger to confirm the pressed position for releasing the locking of the flat connection object and then accurately place their finger at that pressed position and exert a pressing force. In this way, the user can quickly release the locking of the flat connection object, avoiding applying the pressing force at a wrong position.

To fix the upper conductive shell 12 to the insulating housing 16, a plurality of held portions 126A, 126B are formed at two ends and the front edge of the upper conductive shell 12. Each held portion has barbs. Each held portion is inserted into a corresponding holding hole formed in the insulating housing 16 in an interference fit manner. In this way, the upper conductive shell 12 is fixed to the insulating housing 16.

The upper conductive shell 12 also has two fixed portions 124. The fixed portions 124 are fixed to the printed circuit board by soldering. Optionally, the upper conductive shell 12 may be grounded via the fixed portions 124.

In this embodiment, the tactile indicator portion 1221 is formed integrally with the actuator portion 1222. However, in variations of the present invention, the tactile indicator portion may be a separate component formed separately from the upper conductive shell. This additional component can be fixed to the actuator portion using adhesives, binding agent, or solder.

The tactile indicator portion can be made larger in area than the actuator portion. The tactile indicator portion can be formed into a rectangular shape with an aspect ratio ranging from 3:2 to 1:1. This ensures that the tactile indicator portion has an area sufficient for visual indication.

To further enhance the tactile or visual identification of the tactile indicator portion, relief or recessed patterns or characters can be formed on the upper surface of the tactile indicator portion by embossing or stamping, or by printing techniques such as relief printing, intaglio printing, lithography, screen printing, pad printing, transfer printing, and inkjet printing. If necessary, the upper surface of the tactile indicator portion may be colored.

While this invention has been described in reference to a preferred embodiment, it should be understood that numerous changes and modifications could be made within the spirit and scope of the inventive concepts described. Accordingly, it is intended that the invention not be limited to the disclosed embodiment, but that it have the full scope permitted by the language of the following claims.

1. A connector for a flat connection object, the flat connection object comprising a pair of notches and a plurality of electrode portions, the plurality of electrode portions being formed on an insertion end of the flat connection object, the pair of notches being formed on two opposite lateral edges of the flat connection object, the connector comprising:
an insulating housing including an opening for insertion of the flat connection object;
a plurality of contacts held by the insulating housing, each contact including a contact portion extending into the opening and being to be in contact with one of the plurality of electrode portions and a connection terminal portion opposite to the contact portion and extending out of the insulating housing;
an upper electrically conductive shell and a lower electrically conductive shell, the upper electrically conductive shell and the lower electrically conductive shell being fixed to the insulating housing;
wherein the lower electrically conductive shell includes a lower shell body portion and a pair of locking portions respectively positioned on two ends of the lower shell body portion, each locking portion is normally and elastically biased to a locking position, each locking portion includes a pressed portion, a first extension portion and a stop tab, the first extension portion is extended into the opening from the pressed portion, the stop tab is formed on a distant end so that when the flat connection object is inserted into the opening, the stop tabs of the pair of locking portions are engaged with the pair of notches for preventing the flat connection object from being removed from the connector;
the upper electrically conductive shell includes an upper shell body portion and a pair of unlocking portions respectively positioned on two ends of the upper shell body portion, each unlocking portion includes an elastic arm and an actuator portion, the actuator portion is formed on a distant end of the elastic arm and positioned above the pressed portion, the pressed portion is pushed downward by pressing the actuator portion so that the locking portion is biased out of the locking position so as to release locking of the flat connection portion;
each unlocking portion further includes a tactile indicator portion positioned above the actuator portion, the tactile indicator portion has an upper surface which is positioned at a level higher than an upper surface of the upper shell body portion so that unevenness caused by the tactile indicator portion is tactually perceptible for indicating a pressed position for releasing the locking of the flat connection object.

2. The connector of claim 1, wherein the tactile indicator portion is integrally formed with the actuator portion.

3. The connector of claim 1, wherein the tactile indicator portion is formed separately from the upper electrically conductive shell and attached to the actuator by adhesive agent, binding agent or solder.

4. The connector of claim 1, wherein the upper surface of the tactile indicator portion is textured.

5. The connector of claim 1, wherein the upper surface of the tactile indicator portion is formed with a relief or recessed pattern or character.

6. The connector of claim 1, wherein the upper surface of the tactile indicator portion is formed with a printed pattern or character.

7. The connector of claim 1, wherein the upper surface of the tactile indicator portion is colored.

8. The connector of claim 1, wherein each locking portion further includes a U-shaped bent portion and a second extension portion, the second extension portion is extended from the lower shell body portion, and the pressed portion and the second extension portion are connected by the U-shaped bent portion.

9. The connector of claim 1, wherein the actuator portion is formed with a protrusion protruded toward the pressed portion.

10. The connector of claim 1, wherein the stop tab has a front edge inclined toward an insertion direction of the flat connection object, when the flat connection object is inserted into the opening, the insertion end of the flat connection object is abut against the front edge of the stop tab, and further movement of the flat connection object in the insertion direction causes the stop tab to be biased downwardly so that the locking portion is biased away from the locking position.
